(19) United States
(12) Patent Application Publication
(10) Pub. No.: US 2008/0061736 A1
(43) Pub. Date: Mar. 13, 2008

(54) Multi-functional cable

(76) Inventor: Feng-Ming Ho, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/516,479

(22) Filed: Sep. 7, 2006

(51) Int. Cl. H02J 7/02

(52) U.S. Cl. 320/111

(57) ABSTRACT

A multi-functional cable is provided, one side of the cable includes a first transmission port connected to a charger or a personal computer and used to transmit the electric power or the data. The other side of the cable includes a second transmission port and a third transmission port connect with two portable devices to provide the charging current to the portable devices respectively, wherein the second transmission port not only transmit the electric power to the portable device but also provides the function of data transmission between the portable device and the personal computer. It can achieve the purpose that provides the charging current simultaneously to two portable devices from a single charger or a USB port of the personal computer and also support the data transmission at the same time.

### BACKGROUND OF THE INVENTION

1. Field of the Invention

The present invention relates to a charging cable and more especially, relates to a multi-functional cable with charge and data transmission purpose.

2. Description of the Prior Art

The cell phone, the personal digital assistant (PDA) or the digital camera, are some of the most popular and most common portable devices in the market. Conventional charger of the portable device is one by one, one portable device needs one single charger and one charge cable, said, the single charger just can provide charging current to one portable device at a time. However, the plurality of portable devices cannot be charged at the same time under the condition that the amount of the power source plug is limit, for example, in the moving vehicle. It has to charge all portable devices in order. Besides, different kinds of portable device have their own kind of memory for end user to access/carry the data when necessary. Thus, end users have to carry the data transmission cable and different kinds of charger with them at the same time in order to charge the portable device or access the data.

### SUMMARY OF THE INVENTION

According to the issue mentioned previously, the present invention provides a multi-functional cable.

One of objects of this invention is to provide a multi-functional cable. The cable can provide simultaneous charging current to two portable devices from a single charger that has a Universal Serial Bus (USB) port. It not only saves the charging time and the amount of the charger but also enhances the product competition ability furthermore.

Another object of this invention is to provide a multi-functional cable. The cable can collocate with the USB port on the personal computer to transmit the data or to provide the charging current to two portable devices by the power source of the personal computer.

Another object of this invention is to provide a multi-functional cable. One transmission cord of the multi-functional cable is used to provide the charging current to a portable device, and the other transmission cord is used to access/transmit the data between another portable device and the personal computer. Thus, it can save the charger amount and the cable amount that the user has to carry with.

Accordingly, one embodiment of the present invention provides a multi-functional cable including a transmission unit with a mode identification unit; a charging control unit electrically connected to the mode identification unit; and a data transmission control unit electrically connected to the mode identification unit and the charging control unit; a first transmission port having one side electrically connected the transmission unit; a second transmission port having one side electrically connected the transmission unit by a first transmission cord; and a third transmission port having one side electrically connected the transmission unit by a second transmission cord.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a block diagram of the multi-functional cable in accordance with an embodiment of the present invention;

FIG. 2 is an application diagram of the multi-functional cable in accordance with an embodiment of the present invention;

FIG. 3 is a distribution chart of the charging current in accordance with an embodiment of the present invention; and

FIG. 4 is a block diagram of the multi-functional cable in accordance with another embodiment of the present invention.

### DETAILED DESCRIPTION OF THE INVENTION

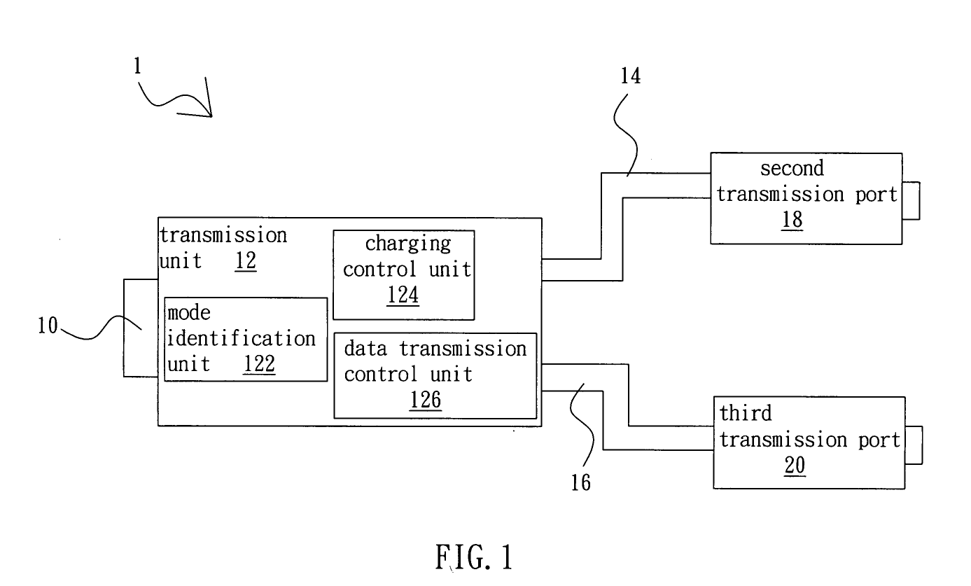

Please refer to FIG. 1, is a block diagram of the multi-functional cable in accordance with an embodiment of the present invention. Shown in the figure, the multi-functional cable 1 includes a transmission unit 12; a first transmission port 10 electrically connected one side of the transmission unit 12, such as a USB port; a second transmission port 18 and a third transmission port 20 electrically connected to the other side of the transmission unit 12, and the second transmission port 18 and the third transmission port 20 being the mini USB plug; a first transmission cord 14 and a second transmission cord 16 electrically connect the transmission unit 12 and the second transmission port 18 and the third transmission port 20 respectively.

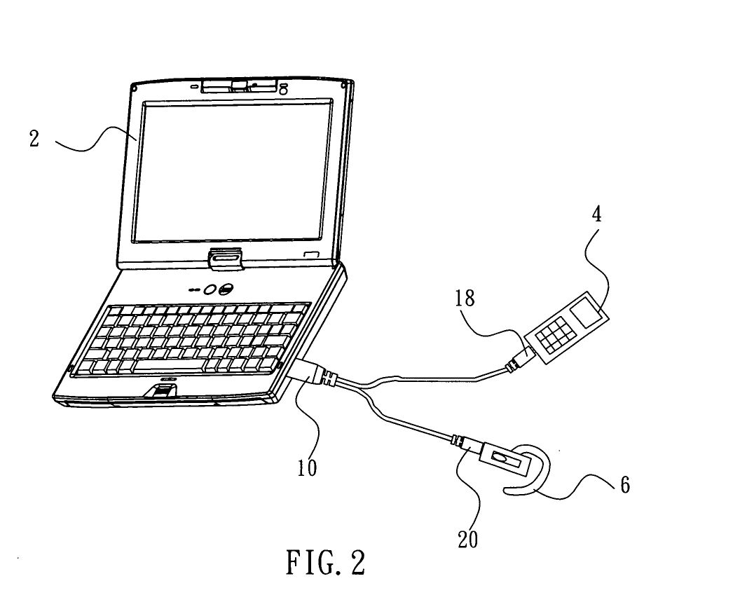

Please refer to FIG. 1 and FIG. 2. In this embodiment, the multi-functional cable 1 provides simultaneous charging current to two portable devices. For example, the first portable device assumed as a cell phone 4 and the second portable device assumed as a bluetooth headset 6, when the user would like to charge the cell phone 4 and the bluetooth headset 6 at the same time on the condition that the plug amount is limit, such as moving vehicle, thus, the user can connect the second transmission port 18 of the multi-functional cable 1 with the cell phone 4, and connect the third transmission port 20 with the bluetooth headset 6. Next, connect the first transmission port 10 with any charger, which has a USB port (not shown), to get the power from the power-line to provide the simultaneous charging current to the cell phone 4 and the bluetooth headset 6 at the same time. Wherein, the charger has to possess the charge capacity that the cell phone 4 and the bluetooth headset 6 need.

However, the source of the charging current in this embodiment is not limited, the charging current can come from the powerline or from the computer 2. The charging current comes from the computer 2 can be done by connecting the first transmission port 10 with the USB port of the computer 2. According to the USB standard specification, there are signals D+ and D− in the USB port and the signal D+ and D− are the differential signals (means D+ and D− will not as high/low voltage level at the same time). When the USB port of the computer 2 detects the connection of the outer device, the USB port of the computer 2 sends a pair of signal D+ and D− to the mode identification unit 122 of the transmission unit 12, then output the logic high (1) or the logic low (0) to control the gain of an operational amplifier (not shown) of the charging control unit 124 by the plurality of logic circuit. And, the output of the operational amplifier controls the duty cycle of two transistors of the transmission unit 12, the duty cycle of two transistors forming a two-segment charging current (shown in FIG. 2) to charge the cell phone 4 and the bluetooth headset 6 respectively.

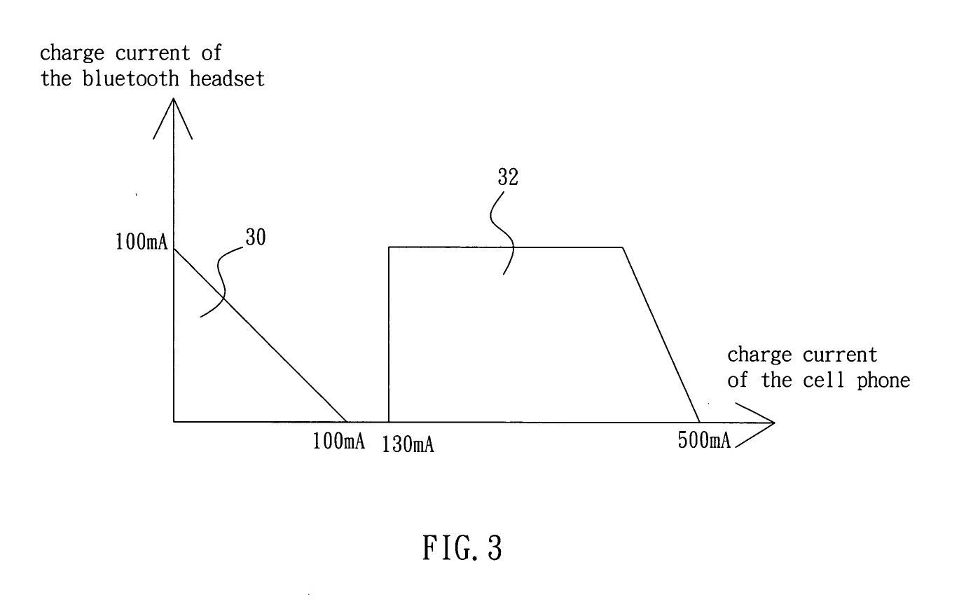

Please refer to FIG. 2 and FIG. 3. When the portable device connects with the USB port of the computer 2 by the multi-functional cable, meanwhile, the USB port detects an unknown device, which connected with the computer 2. Due to the USB firmware of the unknown device does not work to communicate with the computer 2 yet, thus, at that time, the USB port of the computer 2 cannot recognize the unknown device. As the result, the USB port will limit the maximum charging current that is supplied to the unknown device to 100 mA and this stage is called as not-permission mode (shown in FIG. 3, the charging current curve of the not-permission mode be identified as a not-permission area 30). In this embodiment, the cell phone 4 and the bluetooth headset 6 share the 100 mA charging current, which provided by the USB port of the computer 2. After the computer 2 recognizes two portable devices (cell phone 4 and bluetooth headset 6), the USB port switches the charge mode from not-permission mode to permission mode (please refer to FIG. 3, the charging current curve of the permission mode be identified as a permission mode 32) and the maximum charging current of the permission mode 32 that supplied to the cell phone 4 and the bluetooth headset 6 increases to 500 mA, wherein, the comparator of the charging control unit 124 which shown in the FIG. 1 enabled to limit the maximum charging current which supply to the bluetooth headset 6 on the third transmission port 20 to 100 mA. The switch of the maximum charging current is done through the duty cycle variation of the logic signals (logic high and logic low) of the logic circuit of the charging control unit 124 shown in the FIG. 1. The cell phone 4 has higher charging priority than the bluetooth headset in accordance with aforementioned charging modes.

Please refer to FIG. 1 and FIG. 2 again. In this embodiment, the multi-functional cable 1 not only provides simultaneous charging current to the cell phone 4 and the bluetooth headset 6 by connects the first transmission port 10 with the charger or with the computer 2, but also provides the data transmission purpose for the second transmission port 18 by the data transmission control unit 126 of the transmission unit 12. In this embodiment, the cell phone 4 which is connected with the second transmission port 18 can access/save the data between the computer 2 and the cell phone 4 by the data transmission control unit 126 and the first transmission port 10. Understandable, the multi-functional cable 1 can provides the charging current to the bluetooth headset 6 and transmits or accesses the data between the cell phone 4 and the computer 2 at the same time.

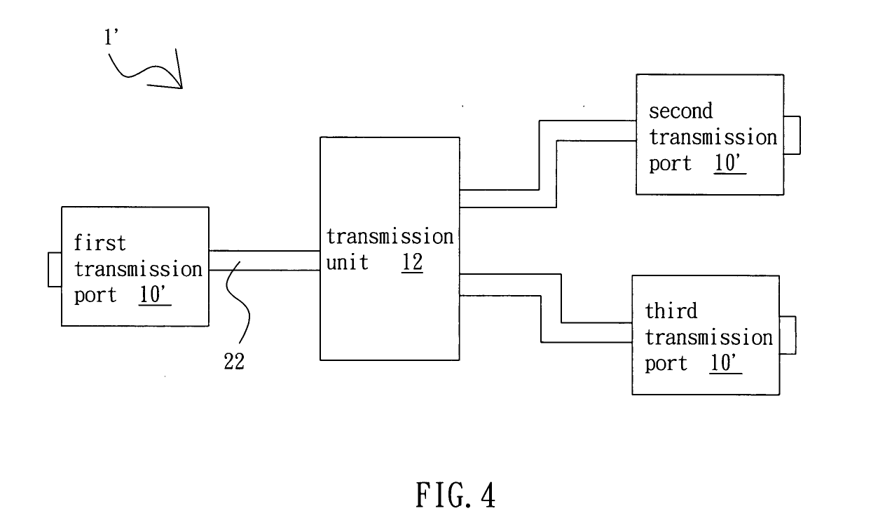

Please refer to FIG. 4, the different between this embodiment and aforementioned embodiment is that the first transmission port 10′ of the multi-functional cable 1′ is not limited to connected to the transmission unit 12 directly, the first transmission port 10′ can electrically connected the transmission unit 12 by a third transmission cord 22 to form a line-cord first transmission port 10′.

Accordingly, the first transmission port is a USB port or a mini USB port and the type of the USB port /mini USB port is not limited; it can be anyone of the plug or the receptacle of series A or series B. Only when the first transmission port is a mini USB port, a mini to A series connector is needed to connect with the USB port of the computer. Besides, the portable device connected to the second transmission port that mentioned previously can be anyone of the cell phone, PDA, music player, digital camera, digital camcorder, or GPS. The portable device connected to the third transmission port that mentioned previously can be any portable device, which has a USB port, such as a bluetooth headset or a cordless speaker. And, the first transmission cord includes a cord collector (not shown) configured between the transmission unit and the second transmission port.

Accordingly, the user just needs one multi-functional cable to achieve the goal that to charge two portable devices at the same time or to charge one portable device and transmit/access the data from the other portable device at the same.

Although the present invention has been explained in relation to its preferred embodiment, it is to be understood that other modifications and variation can be made without departing the spirit and scope of the invention as hereafter claimed.

What is claimed is:

1. A multi-functional cable, comprising:
a transmission unit, comprising:
a mode identification unit;
a charging control unit electrically connected to said mode identification unit; and
a data transmission control unit electrically connected to said mode identification unit and said charging control unit;
a first transmission port, one side of said first transmission port electrically connected said transmission unit;
a second transmission port, one side of said second transmission port electrically connected said transmission unit by a first transmission cord; and
a third transmission port, one side of said third transmission port electrically connected said transmission unit by a second transmission cord.

2. A multi-functional cable according to claim 1, wherein the other side of said first transmission port is electrically connected a charger.

3. A multi-functional cable according to claim 1, wherein the other side of said first transmission port is electrically connected a universal serial bus port of a computer.

4. A multi-functional cable according to claim 1 further comprising a third transmission cord, one side of said third transmission cord electrically connected said transmission unit and the other side of said third transmission cord electrically connected said first transmission port to electrically connect said transmission unit and said first transmission port.

5. A multi-functional cable according to claim 4, wherein said first transmission port is a USB port.

6. A multi-functional cable according to claim 4, wherein said first transmission port is a mini USB port.

7. A multi-functional cable according to claim 1, wherein said first transmission port is a USB port.

8. A multi-functional cable according to claim 1, wherein said first transmission port is a mini USB port.

9. A multi-functional cable according to claim 1, wherein said second transmission port and said third transmission port are mini USB plugs.

10. A multi-functional cable according to claim 1, wherein said second transmission port is electrically connected a portable device that has data access ability.

11. A multi-functional cable according to claim 10, wherein said portable device is a cell phone or a personal digital assistant.

12. A multi-functional cable according to claim 10, wherein said portable device is a music player.

13. A multi-functional cable according to claim 10, wherein said portable device is a digital camera or a digital camcorder.

14. A multi-functional cable according to claim 10, wherein said portable device is a global positioning system.

15. A multi-functional cable according to claim 1, wherein said third transmission port is electrically connected a portable device.

16. A multi-functional cable according to claim 15, wherein said portable device is a bluetooth headset.

17. A multi-functional cable according to claim 15, wherein said portable device is a cordless speaker.

18. A multi-functional cable according to claim 1, wherein said first transmission cord comprises a cord collector configured between said transmission unit and said second transmission port.
